(19) United States
(12) Patent Application Publication
(10) Pub. No.: US 2009/0226780 A1
(43) Pub. Date: Sep. 10, 2009

(54) CATALYST BASED ON A HEXAALUMINATE FOR THE COMBUSTION OF HYDROCARBONS AND FUEL CELL ARRANGEMENT WITH EXHAUST BURNER

(75) Inventors: Richard Fischer, Bad Aibling (DE); Thomas Speyer, Schliersee (DE); Klaus Wanninger, Kolbermoor (DE); Toshio Matsuhisa, Kawasaki (JP)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 12/159,268

(22) PCT Filed: Dec. 28, 2006
(86) PCT No.: PCT/EP2006/012589

§ 371 Date: Oct. 10, 2008

(30) Foreign Application Priority Data
Dec. 29, 2005 (DE) 10 2005 062 926.1

(51) Int. Cl. H01M 8/18; H01M 4/88; H01M 4/90

(52) U.S. Cl. 429/19; 502/101; 502/355

(57) ABSTRACT

The invention relates to a process for producing a catalyst for the catalytic combustion of hydrocarbons, in particular methane, wherein:
a hexaaluminate of the formula MO.6Al₂O₃, where M is at least one alkaline earth metal and the at least one alkaline earth metal and the aluminum can also be partly replaced by at least one other metal, is prepared; and
the hexaaluminate is milled to an average particle size D₅₀ of less than 3 μm.

The invention further relates to a catalyst as can be obtained by the process of the invention, a catalytic burner containing the catalyst and a fuel cell arrangement comprising the catalytic burners.

The invention relates to a process for producing a catalyst for the catalytic combustion of hydrocarbons, in particular methane, a catalyst as can be obtained by the process, a catalytic burner and a fuel cell arrangement.

Fuel cells offer the opportunity of obtaining electric power with high efficiency from the controlled combustion of hydrogen. However, since hydrogen is difficult to store or transport because of the high explosion hazard associated with it, methanol or hydrocarbons are at present used as hydrogen source and hydrogen is then produced from these in an upstream reformer. Methanol is liquid under normal conditions and can therefore be transported and stored without any great problems. Hydrocarbons are either likewise liquid under normal conditions or can easily be liquefied under superatmospheric pressure. In the case of natural gas, which consists essentially of methane, an appropriate infrastructure already exists, so that stationary energy-producing apparatuses based on fuel cells can readily be operated using methane as starting material.

Hydrogen can be liberated from methane by steam reforming. The resulting gas consists essentially of hydrogen, carbon dioxide and carbon monoxide together with traces of unreacted methane and water. This gas can be used as fuel gas for a fuel cell. To shift the equilibrium in steam reforming to the side of hydrogen, reforming has to be carried out at temperatures of about 650° C. To achieve a constant composition of the fuel gas, this temperature should be adhered to as exactly as possible.

A fuel cell arrangement in which the fuel gas produced from methane and water can be utilized for generation of energy is described, for example, in DE 197 43 075 A1. Such an arrangement comprises a number of fuel cells which are arranged in a fuel cell stack within a closed protective housing. Fuel gas consisting essentially of hydrogen, carbon dioxide, carbon monoxide and residual methane and water is fed to the fuel cells via an anode gas inlet. The fuel gas is produced from methane and water in an upstream reformer. On the anode side, the fuel gas is burnt to produce electrons according to the following reaction equations:

CO₃²⁻+H₂→H₂O+CO₂+2e⁻

CO₃²⁻+CO→2CO₂+2e⁻

To achieve a high efficiency of the fuel cell, the reaction is carried out so that it does not proceed to completion. The anode offgas therefore comprises not only the reaction products carbon dioxide and water but also proportions of hydrogen and methane gas. To remove residual hydrogen, the anode offgas is therefore firstly mixed with air and then fed to a catalytic offgas burner in which the remaining methane and traces of hydrogen are burnt to form water and carbon dioxide. The thermal energy released here is utilized to heat the carbonate present in molten form in the fuel cell. As catalysts, use is made of noble metals which are made available in finely divided form on a suitable support. Catalytic combustion has the advantage that it occurs very uniformly and without temperature peaks. Combustion over palladium catalysts proceeds at temperature in the range from about 450 to 550° C. At higher temperatures above about 800-900° C., the Pd/PdO equilibrium shifts to the side of palladium metal, as a result of which the activity of the catalyst decreases (see Catalysis Today 47 (1999) 29-44). The ideal temperature range for operation of a fuel cell is from about 600 to 650° C. The heat evolved during combustion can then be utilized for obtaining the fuel gas by steam reforming. The completely oxidized anode offgas which, in particular, no longer contains any hydrogen gas is, after leaving the burner, fed as cathode gas to the cathode. The carbon dioxide present in the cathode gas reacts with the oxygen and in the process takes up two electrons according to the following equation:

½O₂+CO₂+2e⁻→CO₃²⁻

The present concepts for fuel cells are still relatively costly, so that the plants operated at present have only a pilot character. For wide use to be established, the costs for the provision of an energy generation unit based on fuel cells would therefore have to be drastically reduced.

An important cost factor in the above-described fuel cell arrangement is the noble metal catalyst required for combustion of the anode offgas. Efforts are therefore being made to discover catalysts which have a sufficiently high activity at the required temperatures of about 650° C. and do not contain any costly noble metals.

The catalytic combustion of methane has also been proposed for energy generation from, for example, turbines or other heat sources, but very high temperatures of sometimes more than 1000° C. are generated here.

EP 0 270 203 A1 describes a heat-stable catalyst for the catalytic combustion of, for example, methane. The catalyst is based on alkaline earth metal hexaaluminates containing proportions of Mn, Co, Fe, Ni, Cu or Cr. These catalysts have a high activity and stability even at temperatures of more than 1200° C. However, the activity of the catalyst is relatively low at lower temperatures. To be able to provide a satisfactory catalytic activity even at relatively low temperatures, small amounts of platinum metals, for example Pt, Ru, Rh or Pd, are added.

M. Machida, H. Kawasaki, K. Eguchi, H. Arai, Chem. Lett. 1988, 1461-1464, describe manganese-substituted hexaaluminates A₁₋ₓA′ₓMnAl₁₁O_{19-α} which even after calcination at temperatures of about 1300° C. have a high specific surface area. The hexaaluminates are prepared by the sol-gel process by dissolving appropriate amounts of Ba(OC₃H₇)₂, Sr(OC₃H₇)₂, Ca(OC₃H₇)₂, La(OC₃H₇)₃ and/or Al(OC₃H₇)₃ in isopropanol under a nitrogen atmosphere. An aqueous solution of manganese nitrate and potassium nitrate is added to this solution. The gel formed is decomposed at 500° C. and subsequently calcined at 1300° C. with admission of air. Using this synthetic route, a specific surface area of 23.8 m²/g and a conversion of 10% at a temperature of T_{10%} of 500° C. are achieved for Sr_{0.8}La_{0.2}MnAl₁₁O_{19-α}. This material was also tested in a practical application. H. Sadamori, T. Tanioka, T. Matsuhisa, Catalysis Today, 26 (1995) 337-344 describe the use of the above-described hexaaluminate in a catalytic burner which is installed upstream of a gas turbine. The catalyst was prepared by the alkoxide process and, after precipitation, calcined at 1100° C. The pulverulent catalyst is kneaded with water and an organic binder and then extruded to form a honeycomb structure. After shaping, the catalyst is again calcined at 1200 or 1300°. However, the ceramic catalyst displays a relatively high ignition temperature of more than 600° C. in the combustion of methane. The ceramic catalyst is therefore preceded by sections in which a catalyst containing noble metal is present. The catalyst system was successfully tested in a 160 kW burner which was coupled with a gas turbine. During operation of the experimental arrangement, the temperatures in the catalyst reach values of up to about 1100° C.

The preparation of the hexaaluminates via the sol-gel process is very complicated and therefore too expensive for industrial use. In Applied Catalysis A: General, 104 (1993) 101-108, G. Groppi, M. Bellotto, C. Cristiani, P. Forzatti and P. L. Villa describe a process for preparing hexaaluminates having a large specific surface area. Here, barium nitrate and, if appropriate, manganese nitrate is/are dissolved in water and the solution is acidified to pH=1 by means of nitric acid. Aluminum nitrate is added to this mixture. The clear solution is added to an excess of ammonium carbonate in water, with a pH of from 7.5 to 8.0 being maintained during the entire precipitation reaction. The precipitate is washed, dried and then calcined. Samples which were calcined at temperatures of 1300° C. displayed an activity comparable to that of catalysts obtained via the alkoxide route.

A further way of preparing catalytically active hexaaluminates is described by A. J. Zarur and J. Y. Ying in Nature, 403, (2000), 65-67. They used an inverse emulsion technique for the preparation of the compounds. For this purpose, barium alkoxides and aluminum alkoxides are dissolved in isooctane. An inverse emulsion with water was produced using surface-active compounds. The size of the barium hexaaluminate particles formed is influenced by the amount of water added. The hydrolysis of the metal alkoxides is determined by the diffusion of these compounds from the organic phase into the aqueous phase and proceeds very slowly and uniformly. The nanocrystals obtained in the hydrolysis are separated off from the solvent by lyophilization and then dried under supercritical conditions to keep particle growth of the nanocrystals as low as possible. The nanocrystalline barium hexaaluminate displays an ignition temperature for methane of 590° C. and complete conversion of methane within a temperature range from 710 to 1300° C. The ignition temperature can be reduced to about 400° C. by addition of cerium. Although the process makes it possible to prepare hexaaluminates which display a high catalytic activity in the combustion of methane, the process is too complicated for production of these catalysts on an industrial scale.

To help fuel cell arrangements to attain wide use and thus make an economic breakthrough, it is necessary to reduce production costs considerably. As mentioned above, catalysts containing noble metal are currently being used for the combustion of the anode offgas. Although these have a low ignition temperature and an operating temperature suitable for them to be coupled with fuel cells, their production is very costly due to the high price of the noble metals.

It is therefore a first object of the invention to provide a process by means of which a catalyst for the combustion of hydrocarbons, in particular methane, can be provided in a simple fashion. The catalyst should have a low ignition temperature and an operating temperature which is preferably in the range from 500 to 700° C.

This object is achieved by a process having the features of claim 1. Advantageous embodiments of the process are subject matter of the dependent claims.

It has surprisingly been found that the activity of hexaaluminates can be increased by intensive milling to such an extent that ignition temperatures in the range from 300 to 500° C. and operating temperatures in the range from about 500 to 1100° C. can be achieved in the combustion of methane. This high activity allows, for example, the use of these catalysts in catalytic offgas burners as are required for fuel cell arrangements. The production of the catalysts is very advantageous since they do not rely on the addition of noble metals in order to achieve a high activity. The catalysts are preferably free of noble metals, in particular noble metals of transition group VIII of the Periodic Table of the Elements. The combustion of the anode offgas proceeds to completion even at low temperatures, so that the heat evolved can be utilized directly for steam reforming or for production of the fuel gas. Combustion can in the ideal case be controlled so that no energy has to be removed from the heat evolved from the anode offgas stream in order to be able to achieve the temperatures necessary for steam reforming.

The inventive process for producing a catalyst for the catalytic combustion of hydrocarbons, in particular methane, is carried out by:
providing a hexaaluminate of the formula MO.6Al₂O₃, where M is at least one alkaline earth metal and the at least one alkaline earth metal and the aluminum can also be partly replaced by one or more other metals; and
milling the hexaaluminate to an average particle size D₅₀ of less than 3 μm.

The hexaaluminate can firstly be prepared in any desired way. It is not necessary for the hexaaluminate to be obtained in nanocrystalline or microcrystalline form. The hexaaluminate can be washed and dried in a customary way. If the hexaaluminate is obtained in the form of relatively large agglomerates, it can firstly be comminuted coarsely. The agglomerates can have a very high hardness, so that correspondingly robust apparatuses, for example jaw crushers, are used for comminuting them. After any precomminution has been carried out, the agglomerates are then milled, preferably wet milled, intensively in a suitable mill. Milling can be carried out in a single pass or else preferably in several passes. The mills used are apparatuses which make it possible to comminute very hard aggregates. The hexaaluminate is milled to such an extent that it has an average particle size D₅₀ of less than 3 μm. An average particle size D₅₀ is the value at which 50% of the particles have a smaller particle size and 50% have a larger particle size. The activity of the catalyst increases with increasing degree of comminution of the hexaaluminate. The average particle size D₅₀ is preferably less than 2.5 μm, particularly preferably less than 2.0 μm and very particularly preferably in the range from 0.5 to 1.9 μm. It has been found that the particle size distribution does not exert any extraordinary influence on the activity of the catalyst. It is therefore not necessary to strive for a very narrow particle size distribution. However, the particle size distribution should not be too broad so that, in particular, the proportion of larger particles cannot become too great. D₇₀ is preferably less than 6 μm, more particularly less than 4 μm, more particularly less than 3.8 μm and particularly preferably in the range from 3.7 to 4.2 μm.

The composition of the hexaaluminate itself corresponds to that of the hexaaluminates which have been proposed in the past for use in the catalytic combustion of hydrocarbons. Preference is given to using alkaline earth metal hexaaluminates, with both the alkaline earth metal and the aluminum being able to be partly replaced by other metals. Such other metals can be, for example, alkali metals or transition group metals.

The hexaaluminate is preferably calcined at a temperature above 1050° C., particularly preferably above 1100° C., before milling. Above 1000° C., a mineral phase can advantageously be formed. This measure makes the hexaaluminate largely insensitive to exposure to temperatures below the calcination temperature. When used in a catalytic burner for the anode offgas of a fuel cell arrangement, the hexaaluminate is, for example in the above-described fuel cell arrangement, subjected to a temperature in the range from 500 to 700° C., in particular about 650° C. Since the hexaaluminate has already been calcined at a higher temperature, a long life of the catalytic burner is therefore ensured.

The calcination temperature can also be higher if the catalytic burner is, for example, to be operated at a temperature higher than is necessary in combination with a fuel cell. Thus, for example, calcination temperatures up to 1300° C. are also possible.

The hexaaluminate is particularly preferably calcined before milling.

In particular, the hexaaluminate is firstly subjected to a precalcination at low temperature and subsequently to a main calcination at higher temperature. The calcination temperature of the precalcination is for this purpose selected so as to be relatively low, preferably in the range from 500 to 900° C., particularly preferably in the range from 600 to 800° C. In the main calcination, the hexaaluminate is then preferably calcined again at higher temperatures than in the precalcination. The temperature in the main calcination is preferably in the range from 900 to 1400° C., particularly preferably in the range from 1050 to 1200° C. At these high temperatures, a mineral phase of the hexaaluminates can be formed.

As indicated above, the hexaaluminates have a high hardness. For this reason, milling is preferably carried out by slurrying the hexaaluminate in water for milling and subsequently milling it in a suitable mill, preferably a ball mill.

The milling process is preferably carried out stepwise, with the particle size of the hexaaluminate being reduced in steps. Thus, coarse milling is preferably carried out between precalcination and main calcination. This coarse milling is preferably carried out dry. In the coarse milling, the particle size D₅₀ of the coarse powder is preferably brought to a value in the range from 5 to 50 μm. This coarse powder is then preferably slurried in water and milled wet in a fine milling step to give a very fine particle size.

The preparation of the hexaaluminate is preferably carried out by
preparing an aqueous solution of at least one alkaline earth metal nitrate;
acidifying the aqueous solution of the at least one alkaline earth metal nitrate to a pH of less than 2;
adding an aluminum salt to the acidified aqueous solution of the at least one alkaline earth metal nitrate to give a clear aluminum-containing solution;
providing an aqueous solution of (NH₄)₂CO₃ containing an excess of (NH₄)₂CO₃;
adding the clear aluminum-containing solution to the (NH₄)₂CO₃ solution, with a pH of greater than 7.5 being maintained while the solutions are combined; and
separating the precipitated hexaaluminate from the mixture obtained.

The preparation by precipitation of the hexaaluminate from aqueous solution essentially follows the above-described synthetic route as discovered by Groppi et al. loc. cit. This makes possible an inexpensive preparation of the hexaaluminate which can also be carried out on an industrial scale.

In carrying out the preparation, an aqueous solution of an alkaline earth metal nitrate is firstly prepared. For this purpose, the corresponding alkaline earth metal nitrate is dissolved in deionized water. If appropriate, further metal salts can also be added to this solution, preferably likewise in the form of their nitrates. The alkaline earth metal nitrate solution is subsequently acidified to a pH of less than 2, in particular less than 1. Nitric acid is preferably used for this purpose. An aluminum salt is subsequently introduced into the acidified aqueous alkaline earth metal nitrate solution, resulting in formation of a clear solution. Preference is given to using aluminum nitrate, particularly preferably the nonahydrate, as aluminum salt. In a reservoir, an aqueous solution of (NH₄)₂CO₃ is made ready, with the concentration being chosen so that an excess of (NH₄)₂CO₃ based on the neutralization of the acidic aluminum-containing solution is made available. The clear aluminum-containing solution is then introduced into the (NH₄)₂CO₃ solution with preferably vigorous stirring. The mixture can be heated during this addition, preferably to temperatures in the range from 50 to 80° C., preferably from 55 to 70° C. Vigorous evolution of gas is observed during the addition of the (NH₄)₂CO₃ solution. During the addition of the (NH₄)₂CO₃ solution, the pH of the mixture is kept in the range above 7.5, preferably in the range from 7.5 to 8.0. If appropriate, the rate of addition of the acidic aluminum-containing solution is adjusted accordingly.

In a preferred embodiment, the precipitate formed is aged. Aging is preferably carried out for a period of from 30 minutes to 8 hours, particularly preferably for a period of from 3 to 6 hours. The temperature of the slurry during aging is preferably kept in the range from 40 to 80° C., particularly preferably from 50 to 70° C.

The precipitate is subsequently separated off, preferably by filtration, washed with deionized water, preferably until nitrate can no longer be detected in the filtrate, and subsequently dried at temperatures of preferably from 90 to 140° C., particularly preferably from 100 to 120° C.

After drying, the solid obtained can be precomminuted if appropriate and then, as described above, firstly be precalcined at 500-900° C., then milled dry and subsequently subjected to the main calcination at 1050-1200° C. and then intensively milled wet.

In a particularly preferred embodiment, the hexaaluminate is a compound of the formula A_{1-z}B_{z}CₓAl_{12-y}O_{19-α}, where:
A: at least one element from the group consisting of Ca, Sr, Ba and La;
B: at least one element from the group consisting of K and Rb
C: at least one element from the group consisting of Mn, Co, Fe and Cr
z: a number in the range from 0 to 0.4;
x: a number in the range from 0.1 to 4;
y: a number in the range from x to 2x; and
α: a number determined by the valences of the other elements.

In the formula shown above, α corresponds to a number determined by the valences of the other constituents and their proportion in the hexaaluminate. The number α is given by:

α=1½{x−z(x−y)+xz−3y}.

In the preparation of the hexaaluminate, the individual components, i.e. the metal salts, in particular nitrates, of the metals A, B and C, are preferably used in a ratio of Al:(A*B):C of 100:(7-10):(0.1-4).

Particularly preferred materials are BaMnAl₁₁O₁₉₋ₓ and LaMnAl₁₁O₁₉₋ₓ, where x corresponds to the oxygen deficit.

The hexaaluminate obtained by the process of the invention has a low ignition point for the combustion of methane and displays a high activity, even at relatively low temperatures, in particular in the range from 600 to 700° C., so that the combustion of methane proceeds to completion and occurs at high conversion rates. The invention therefore also provides a catalyst as has been obtained by the above-described process.

In a particularly preferred embodiment, the catalyst has a specific surface area of more than 6 m²/g, particularly preferably more than 15 m²/g.

As a result of the intensive milling carried out during the preparation, the catalyst of the invention at the end has a particle size having a D₅₀ of less than 3 μm. This particle size can also be determined on the finished catalyst. For this purpose, the finished catalyst can, for example, be scratched off from a surface and the powder obtained can be sieved to a particle size of from 80 to 250 μm. The sieved powder is slurried in distilled water in a conical flask and the conical flask is held in an ultrasonic bath for 30 minutes. The particle size distribution is subsequently measured in the presence of ultrasound and with stirring over a period of 1 minute.

As indicated above, the catalyst of the invention has a low ignition temperature for the combustion of methane and preferably an operating temperature in the range from about 600 to 700° C. The invention therefore also provides a catalytic burner containing the above-described catalyst.

The catalyst can be provided in granular form, as shaped bodies or preferably as coating on a suitable support. For example, the catalyst can be mixed with water and a suitable organic or inorganic binder and then extruded to form shaped bodies. However, the catalyst is, if appropriate in admixture with a suitable binder, preferably slurried in water or another suitable solvent, for example an alcohol or alcohol/water mixture, and then applied to a suitable support by painting, spraying or dipping.

The support is preferably configured as a monolith. The catalyst can then be applied to the surface of the monolith by simple dipping. After drying, the coating can, if appropriate, be fixed to the surface of the support by means of a calcination step. Such a coated monolith can be installed very simply in the offgas stream, for example from a fuel cell.

To offer very little resistance to the gas stream and also to provide a very large catalyst area, the monolith preferably has a honeycomb structure. The catalytic burner of the invention then has a plurality of parallel offgas channels which can also be connected by connecting openings in the sides of the channels in order to be able to even out pressure fluctuations within the gas stream.

The monolith preferably consists of a ceramic material or a suitable metal, for example a stainless steel, which can withstand the temperatures occurring in the gas stream during combustion, so that a long operating life of the catalytic burner is ensured.

The catalytic burner of the invention has a low ignition temperature for hydrocarbons, in particular methane. Furthermore, it displays high conversion rates and virtually complete combustion of the gases fed in. It is therefore possible for even small amounts of hydrocarbons, in particular methane, and hydrogen to be burnt reliably using the catalytic burner of the invention. The catalytic burner of the invention is therefore particularly suitable for use in a fuel cell arrangement to achieve virtually complete combustion of the anode offgas.

The invention therefore also provides a fuel cell arrangement having a number of fuel cells which are arranged in a fuel cell stack and having an anode inlet for supplying fuel gas to the anodes of the fuel cells, an anode outlet for discharging the burnt fuel gas from the anodes, a cathode inlet for supplying cathode gas to the cathodes of the fuel cells and a cathode outlet for discharging the spent cathode gas from the cathodes. According to the invention, the anode outlet of the fuel cells is provided with a catalytic burner as has been described above in which residual hydrocarbons, in particular methane, and residual hydrogen are burnt after mixing-in of air.

A reformer for steam reforming of hydrocarbons, in particular methane, is preferably provided, as is a heat exchanger by means of which heat produced in the catalytic burner is conveyed to the reformer. In this way, the heat produced in the catalytic burner can be utilized for preconditioning the fuel gas.

In a preferred embodiment, the fuel cells are configured as molten carbonate fuel cells (MCFCs). In this type of fuel cell, the membrane between anode compartment and cathode compartment of the fuel cell is formed by a layer of a molten carbonate, for example lithium-potassium carbonate. The heat produced by the catalytic burner can be utilized for keeping the carbonate in molten form.

A cathode gas conduit by means of which the offgas leaving the catalytic burner is conveyed as cathode gas to the cathode inlet is preferably provided. To regenerate the carbonate on the cathode side, the MCFC requires carbon dioxide to be provided. Recirculation of the offgas produced in the catalytic burner as cathode gas enables the carbon dioxide present therein to be utilized for regenerating the molten carbonate membrane.

In a particularly preferred embodiment, a protective housing which surrounds the fuel cell stack and the catalytic burner and within which the fuel gas stream circulates is provided. In this way, the fuel cell arrangement can, firstly, be made very compact and, secondly, the circulating gas streams can be optimally utilized for the generation of energy.

The invention is illustrated below with the aid of examples and with reference to the accompanying figures. The figures show:

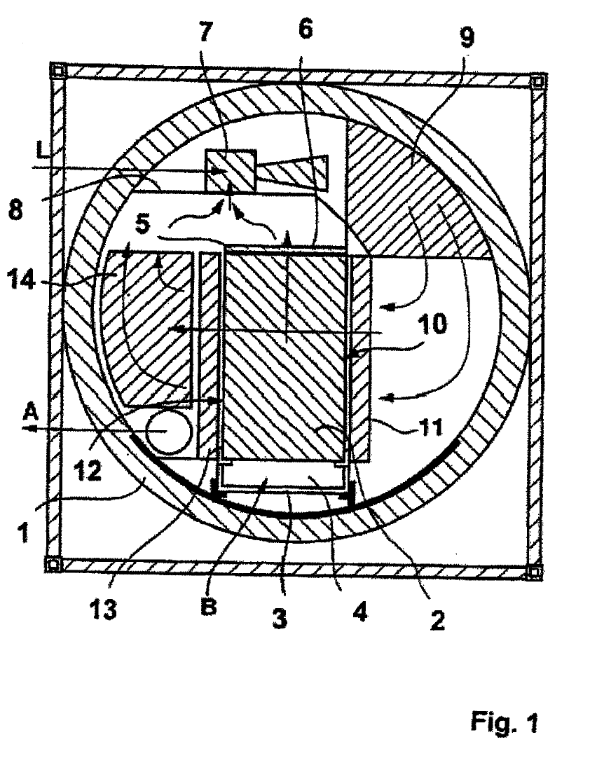

FIG. 1: a fuel cell arrangement as described in DE 197 43 075 A1;

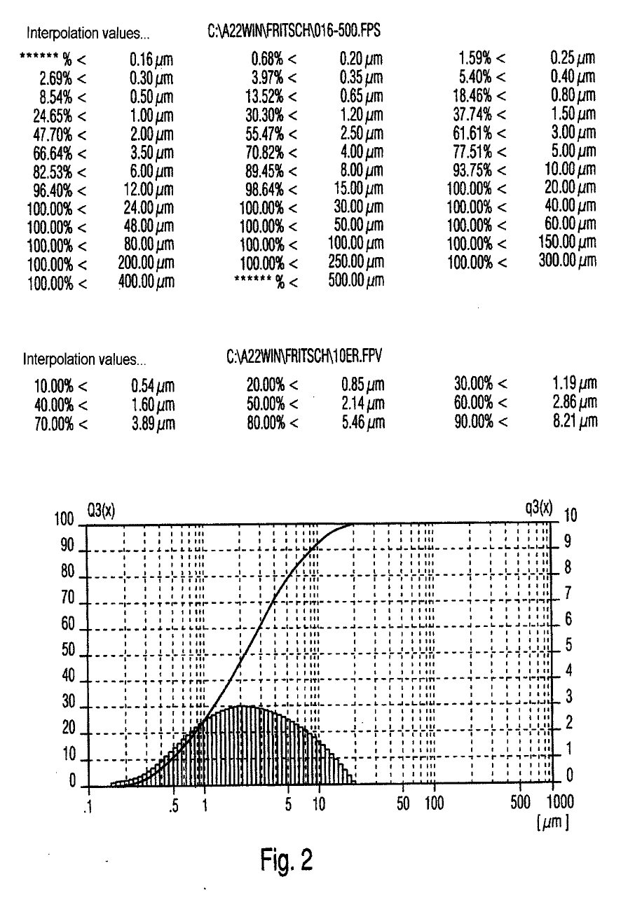

FIG. 2: a particle size distribution of a hexaaluminate after four passes through a ball mill;

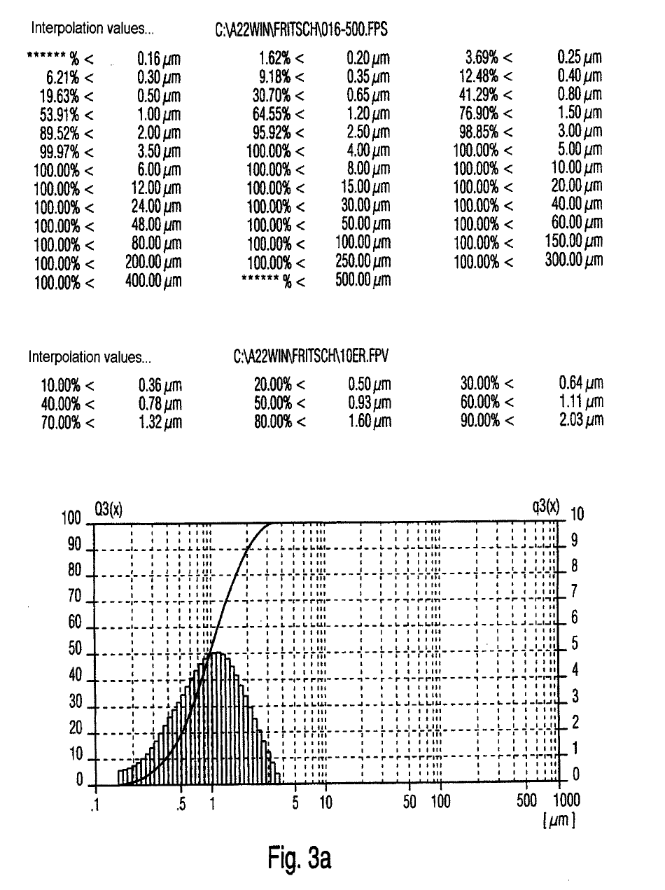

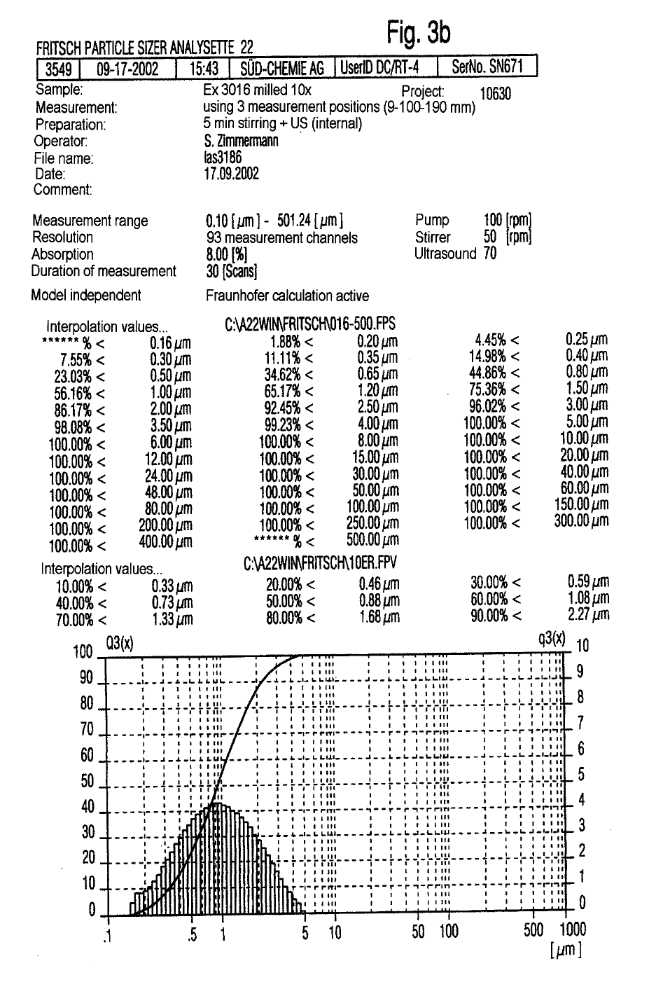

FIG. 3: a particle size distribution of a hexaaluminate after ten passes through a ball mill;

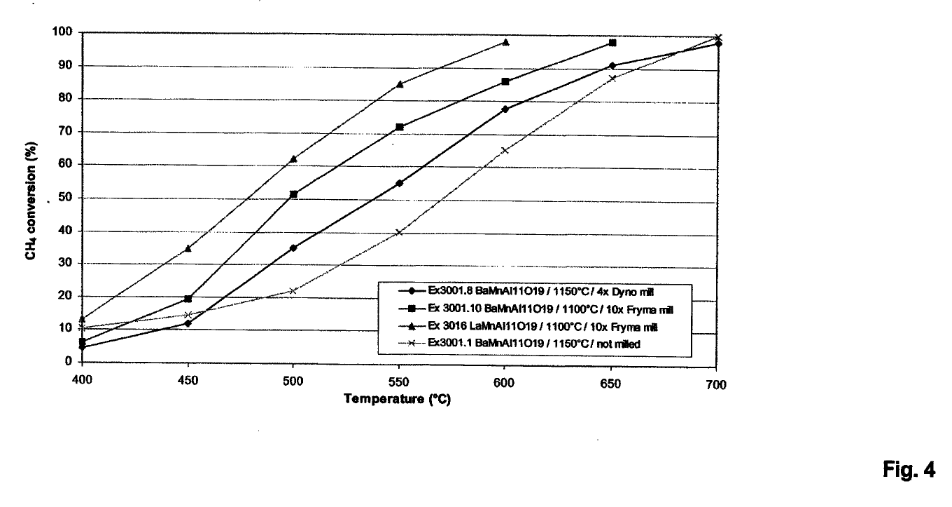

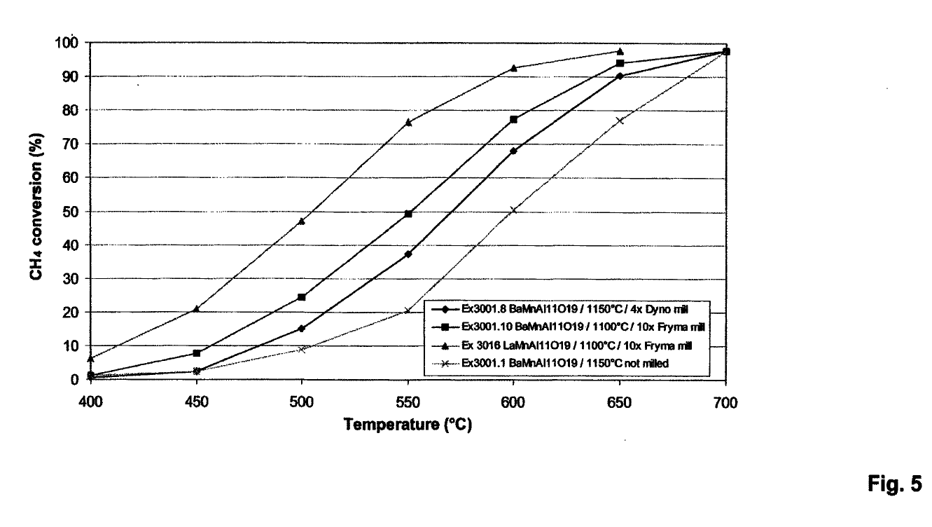

FIG. 4: a graph of the methane conversion as a function of the temperature for a measurement gas containing 1000 ppm of methane in air;

FIG. 5: a graph of the methane conversion as a function of the temperature for a measurement gas containing 1000 ppm of methane and 3000 ppm of hydrogen in air;

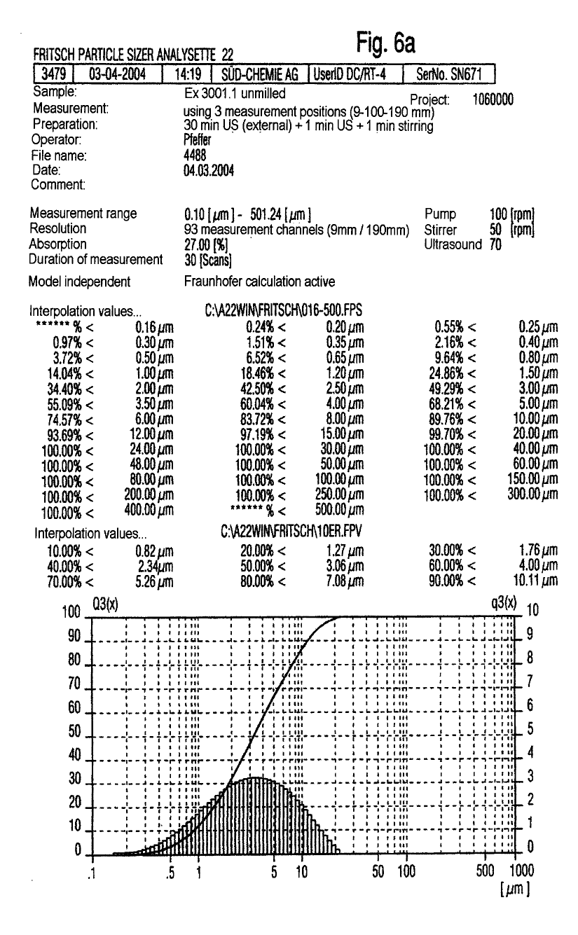

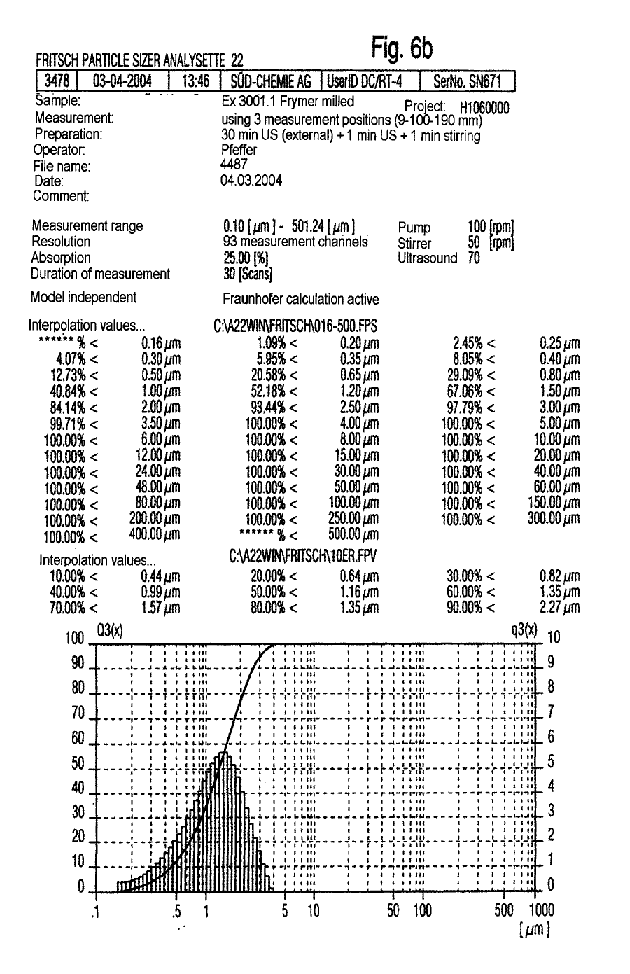

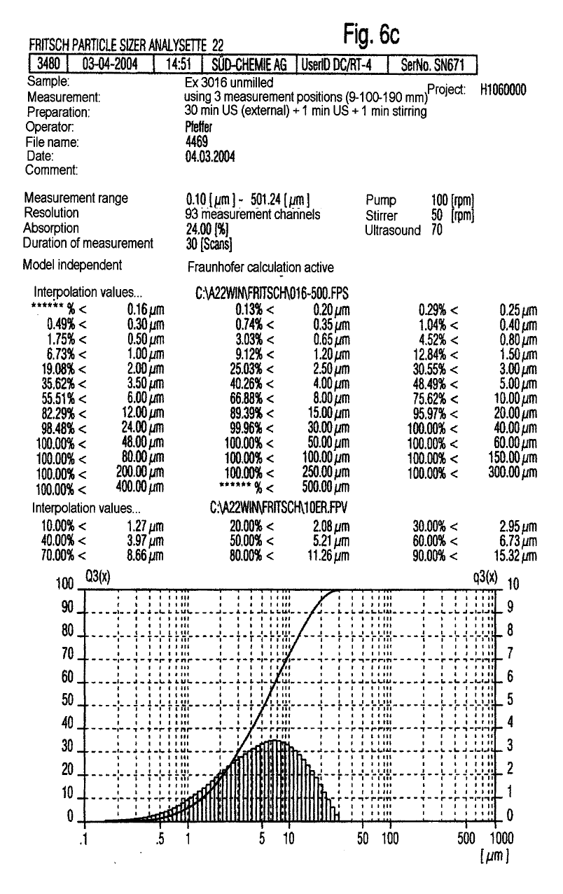

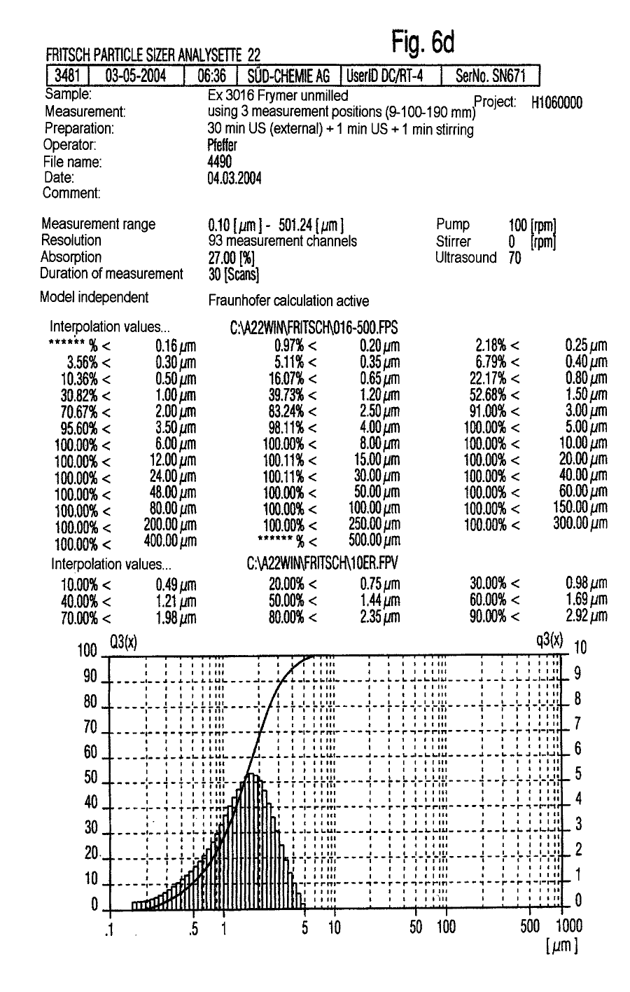

FIG. 6: a particle size distribution of a catalyst powder obtained from a washcoat produced using the following samples:
a) BaMnAl₁₁O₁₉₋ₓ unmilled (Ex 3001.1)
b) BaMnAl₁₁O₁₉₋ₓ milled 10× (Ex 3001.1)
c) LaMnAl₁₁O₁₉₋ₓ unmilled (Ex 3016)
d) LaMnAl₁₁O₁₉₋ₓ milled 10× (Ex 3016)

FIG. 1 shows a front view of a section through a fuel cell arrangement which is as shown in FIG. 2a of DE 197 430 75 A1 but comprises the catalytic burner of the invention. A fuel cell arrangement whose main constituent is a number of fuel cells arranged in a fuel cell stack 2 is located in a protective housing 1 which is gastight and thermally insulating. The fuel cells contain anodes (not shown) through which a fuel gas B flows vertically from the bottom upward and cathodes (not shown) through which a cathode gas flows in a horizontal direction transverse to the flow through the anodes. For this purpose, a fuel gas channel 3 via which the fuel gas is supplied to an anode inlet 4 is provided at the lower end of the fuel cell stack. The fuel gas channel separates the anode inlet 4 from the interior of the protective housing 1 in a gastight manner. The fuel gas has been produced from methane and water according to the water gas equilibrium in a reformer (not shown) and comprises essentially hydrogen, carbon monoxide and carbon dioxide together with residues of unreacted methane and water. The fuel gas flows through the anode chamber of the fuel cells in a vertical direction and leaves the anode chamber again at the anode outlet 5. After passing through a diffuser 6 in which a uniform gas stream is produced, the anode offgas stream is drawn in by an ejector 7. The ejector 7 is driven by a stream of air according to the principle of a water jet pump, with the stream of air being compressed by means of an external pump and then ejected through a nozzle. The ejector 7 is arranged in a separate chamber which is bounded by the manifold 8 and the outer wall of the protective housing 1. From the outlet end of the ejector 7, the gas stream mixed with air is conveyed to a catalytic burner 9 in which combustible components of the anode offgas which are still present in the gas stream are burnt catalytically. The combustion chamber of the catalytic burner 9 is coated with a hexaaluminate which has been prepared by the process of the invention. The gas stream leaving the catalytic burner 9 is fed to the cathode inlet 10. The cathode inlet 10 is preceded by a preheater and diffuser 11 in which a uniform gas stream is produced. During start-up of the fuel cell arrangement, the gas stream can be heated to the required operating temperature by means of the preheater and diffuser 11. During normal operation, sufficient thermal energy is produced by the catalytic burner 9 for the gas stream not to have to be additionally heated. At the cathode inlet 10, the cathode gas stream enters the cathode compartments of the fuel cells and passes through these in a horizontal direction and leaves the cathode compartment again at the cathode outlet 12. Downstream of the cathode outlet 12, the spent cathode offgas flows through a heat exchanger 13 in which heat is withdrawn from the cathode offgas. This heat is used for preheating the fuel gas. The cathode offgas subsequently flows through a further heat exchanger 14 by means of which further heat is taken from the circulating offgas. This heat can, for example, be utilized for producing the fuel gas in a reformer. Excess cathode offgas is discharged from the protective housing 1 via the offgas conduit A. The offgas corresponds to the chemical equivalent of the streams of fresh air L and fuel gas B fed to the fuel cell arrangement. The operating point of the fuel cell arrangement as equilibrium state is established as a result of the quantity of heat withdrawn in the heat exchanger 14 and the discharged offgas A. The remaining cathode offgas is mixed with the anode offgas and fed back into the ejector 7 via the feed hood 8.

### Analytical Methods

### Surface Area/Pore Volume:

The specific surface area is determined on a fully automatic nitrogen porosimeter from Micromeritics, model ASAP 2010, in accordance with DIN 66131.

### Determination of the Average Particle Size

The particle size is determined by laser light scattering on a “Fritsch Particle Sizer Analysette 22” in the presence of ultrasound and with stirring. The D₅₀, i.e. 50% of all particles <x μm, is reported.

### Preparation of the Hexaaluminates:

The hexaaluminates were prepared by a method corresponding to that published by Groppi et al. loc. cit.

### EXAMPLE 1

### BaMnAl₁₁O₁₉₋ₓ Milled 4× by Dyno-Mill®

786 g of barium nitrate (52.4% Ba) and 1074 g of manganese nitrate (50% manganese) are placed in a first vessel and made up to 30 l with demineralized water. The pH of the solution is set to 1 by means of concentrated nitric acid. 12.38 kg of aluminum nitrate nonahydrate are then dissolved therein and the solution is heated to 70° C.

In a second vessel, a solution of 12 kg of ammonium carbonate in 60 l of demineralized water is prepared and heated to 55° C. A precipitation vessel provided with a stirrer is charged with a little water and a pH probe is installed. The two solutions are then pumped simultaneously into the precipitation vessel at such rates that the pH is maintained in the range from 7.5 to 8. Care is taken to ensure that the pH does not drop below 7.5.

The suspension obtained is aged for one hour and the precipitate is then separated off by means of a filter press. The precipitate is washed with water at 70° C. and then separated off by filtration. The precipitate is subsequently dried at 120° C. in a drying oven for 48 hours. The dried precipitate is coarsely milled (D₅₀<20 μm) and precalcined at 750° C. for 3 hours. The precalcined precipitate is subsequently calcined again at 1150° C. for 16 hours.

The pulverulent hexaaluminate is slurried in 4 liters of water and the slurry is milled in a ball mill (Dyno-Mill®, from WA Bachofen, Switzerland) having a milling space which has a volume of 250 ml and is filled with zirconium oxide balls having a diameter of 1 mm. The suspension is pumped 4 times through the 250 ml milling space, with the speed of the mill being set to 4000 min⁻¹. The particle size distribution of the suspension after milling is shown in FIG. 2.

The finely milled suspension is dried at 120° C.

A suspension having a solids content of 50% is prepared from the dried powder and water. This suspension is either applied to catalyst supports such as honeycombs or brought into a form in which the catalyst is to be used. After coating or shaping, the catalyst is dried again and calcined once more at 450° C. to achieve satisfactory adhesion of the powder particles.

To carry out the activity tests, a granular material whose particles have a diameter of from 250 to 500 μm is produced. The granulated catalyst has a BET surface area of 19 m²/g.

### EXAMPLE 2

### BaMnAl₁₁O₁₉₋ₓ Milled 10× by Fryma® Mill

BaMnAl₁₁O₁₉₋ₓ is firstly prepared by a method analogous to Example 1. The hexaaluminate calcined at 1150° C. is slurried in 5 l of water. This suspension is pumped 10 times through a ball mill from Fryma (Rheinfelden) model MS-32 having a 3.4 l milling space (2.4 l of 1 mm balls). This ball mill is an even more efficient annular gap ball mill. After the milling process, the suspension has an average particle size D₅₀ of 0.93 μm. The particle size distribution is shown in FIG. 3a. The finely milled suspension is subsequently dried at 120° C.

A suspension having a solids content of 50% is prepared from the dried powder and water. This suspension can either be used to coat catalyst supports such as honeycombs or is brought into a form in which the catalyst is to be used. After coating or shaping, the catalyst is dried again and calcined once more at 450° C. to establish firm adhesion between the powder particles.

To carry out the activity tests, a granular material whose particles have a diameter of 250-500 μm is produced.

### EXAMPLE 3

### LaMnAl₁₁O₁₉₋ₓ Milled 10× Using a Fryma® Mill

650 g (2 mol) of lanthanum nitrate and 716 g of manganese nitrate (50% manganese) (2 mol) are placed in a first vessel and made up to 25 l with demineralized water. The pH of the solution is set to 1 by means of concentrated nitric acid. 8.257 kg of aluminum nitrate nonhydrate are then introduced into the solution and the solution is heated to 60° C.

In a second vessel, a solution of 8 kg of ammonium carbonate in 45 l of demineralized water is prepared and heated to 50° C. A precipitation vessel provided with a stirrer is charged with a little water and a pH probe is installed. The two solutions are then pumped simultaneously into the precipitation vessel at such rates that the pH is maintained in the range from 7.5 to 8. The addition is carried out so that the pH does not drop below 7.5.

The suspension is aged for one hour and the precipitate is subsequently separated off by filtration through a filter press. The solid obtained is washed once with hot water at 70° C. and subsequently separated off again by filtration. The precipitate is subsequently dried at 120° C. for 48 hours. The dried precipitate is coarsely milled to an average particle size D₅₀ of <20 μm and the milled solid is precalcined at 750° C. for 3 hours. The precalcined solid is subsequently calcined again at 1100° C. for 16 hours.

The hexaaluminate calcined at 1100° C. is slurried in 5 l of water. This suspension is pumped 10 times through a ball mill from Fryma (Rheinfelden) model MS-32 having a 3.4 l milling space (2.4 l of 1 mm balls). The average particle size D₅₀ of the solid present in the suspension was measured as 0.88 μm. The particle size distribution is shown in FIG. 3b.

The finely milled suspension is dried at 120° C. and a suspension in water having a solids content of 50% is again prepared from the dry powder. This suspension can either be used to coat a catalyst support such as a honeycomb or the hexaaluminate is brought into a form in which the catalyst is to be used. The catalyst is subsequently dried again and calcined once more at 450° C. to achieve satisfactory adhesion between the grains of the catalyst.

To carry out the activity tests, a granular material having a diameter of from 250 to 500 μm is produced from the pulverulent hexaaluminate.

### EXAMPLE 4

### Comparative Example

A hexaaluminate is prepared by a method analogous to Example 1. After calcination at 1150° C., the solid is likewise milled to a particle size of 250-500 μm but dry.

To carry out the activity tests, a granular material having a diameter of from 250 to 500 μm is produced from the pulverulent hexaaluminate.

### EXAMPLE 5

### Activity Measurements

The granular catalysts produced in Examples 1 to 4 are tested in the oxidation of methane and hydrogen in a microreactor. Here, the granular material is introduced into a reactor having an internal diameter of 8 mm. A gas mixture comprising 1000 ppm of methane in synthetic air (20% O₂/80% N₂) or a gas mixture comprising 1000 ppm of methane and 3000 ppm of hydrogen in synthetic air is passed through the reactor at a space velocity of 40 000 h⁻¹. Conversion curves as a function of temperature were produced using this gas mixture. These are shown in FIG. 4 and FIG. 5.

FIG. 4 shows the methane conversion for three barium hexaaluminate samples which have been milled to different degrees and a lanthanum hexaaluminate sample as a function of temperature. A gas containing 1000 ppm of methane in air was used as test gas. The GHSV was 40 000 h⁻¹. It can be seen that the activity of the catalyst increases with decreasing particle size.

In a further trial, the combustion of a gas mixture containing 3000 ppm of hydrogen and 1000 ppm of methane in air was examined. This hydrogen/methane ratio of 3/1 is encountered approximately at the outlet of most fuel cell systems.

FIG. 5 shows the methane conversion as a function of temperature for catalysts which have been milled to different degrees. The conversion of methane is influenced only slightly by the presence of hydrogen. The catalyst LaMnAl₁₁O₁₉₋ₓ displays a conversion of more than 90% at 600° C. At 450° C., a conversion of 20% is achieved. The ignition temperature for hydrogen is 200° C. The catalyst is therefore suitable as catalytic burner for the anode offgas of a fuel cell at temperatures above 200° C. To ignite the catalyst, it is merely necessary to heat it to a temperature of about 200° C. The required temperature is subsequently set and maintained by regulating the material and heat flows in the fuel cell. To preheat the catalytic burner, it is possible to provide, for example, a small platinum precatalyst in which the hydrogen can be ignited at lower temperatures.

### EXAMPLE 6

### Determination of the Particle Size Distribution of a Catalyst from the Washcoat After Coating

A suspension is prepared in each case from the various hexaaluminates BaMnAl₁₁O₁₉₋ₓ and LaMnAl₁₁O₁₉₋ₓ obtained in Examples 1 to 4. The unmilled material and the pulverulent material which has been milled 10 times is in each case used for this purpose.

500 g of the powder are in each case stirred a little at a time into 500 ml of water using an Ultra-Turrax® stirrer. As soon as the viscosity of the suspension increases, a total of 6 g of concentrated acetic acid are in each case added dropwise. The suspension is subsequently briefly milled once more in a ball mill (Dyno-Mill®, WAB, Switzerland) filled with zirconium oxide balls having a diameter of 1 mm. The suspension is subsequently spread out to form a thin film and dried. The dried coating is scratched off and the powder obtained is sieved to a particle size of from 80 to 250 μm.

100 mg of the sieved powder are slurried in 100 ml of distilled water in a conical flask and the conical flask is kept in an ultrasonic bath for 30 minutes. The particle size distribution is subsequently measured in a Fritsch Particle Sizer Analysette 22 in the presence of ultrasound and with stirring for 1 minute.

The measured curves are shown in FIGS. 6 a to d. Only in the case of the previously finely milled samples is a low average particle diameter D₅₀ of less than 1.5 μm found in the detached washcoat. In the case of BaMnAl₁₁O₁₉₋ₓ, a D₅₀ of 3.06 μm is found for the unmilled catalyst and a D₅₀ of 1.16 μm is found for the milled catalyst. In the case of LaMnAl₁₁O₁₉₋ₓ, a D₅₀ of 5.21 μm is found for the unmilled catalyst and a D₅₀ of 1.44 μm is found for the milled catalyst. The particle size of the catalyst can therefore also be determined from the finished catalyst coating applied to a support.

1. A process for producing a catalyst for the catalytic combustion of hydrocarbons, in particular methane, wherein:
a hexaaluminate of the formula A_{1-z}B_{z}CₓAl_{12-y}O_{19-α}, where:
A: at least one element selected from the group consisting of Ca, Sr, Ba and La;
B: at least one element selected from the group consisting of K and Rb
C: at least one element selected from the group consisting of Mn, Co, Fe and Cr
z: a number in the range from 0 to 0.4;
x: a number in the range from 0.1 to 4;
y: a number in the range from x to 2x; and
α: a number which is determined by the valences of the other elements and corresponds to the oxygen deficit,
is prepared; and
the hexaaluminate is milled to an average particle size D₅₀ of less than 3 μm.

2. The process as claimed in claim 1, characterized in that the hexaaluminate is calcined at a temperature of more than 1050° C. before milling.

3. The process as claimed in claim 1, characterized in that the hexaaluminate is milled by slurrying it in water and subsequently milling it in a ball mill.

4. The process as claimed in claim 1, characterized in that the hexaaluminate is prepared by a process comprising
preparing an aqueous solution of at least one alkaline earth metal nitrate;
acidifying the aqueous solution of the at least one alkaline earth metal nitrate to a pH of less than 2;
adding an aluminum salt to the acidified aqueous solution of the at least one alkaline earth metal nitrate to give a clear aluminum-containing solution;
providing an aqueous solution of (NH₄)₂CO₃ containing an excess of (NH₄)₂CO₃;
adding the clear aluminum-containing solution to the (NH₄)₂CO₃ solution, with a pH of greater than 7.5 being maintained while the solutions are combined; and
separating the precipitated hexaaluminate from the mixture obtained.

5. The process as claimed in claim 4, characterized in that the precipitate formed by combining the clear aluminum-containing solution and the (NH₄)₂CO₃ solution is aged after the solutions have been combined.

6. (canceled)

7. A catalyst for the combustion of hydrocarbons, in particular methane, comprising a hexaaluminate of the formula A_{1-z}B_{z}CₓAl_{12-y}O_{19-α}, where:
A: at least one element selected from the group consisting of Ca, Sr, Ba and La;
B: at least one element selected from the group consisting of K and Rb
C: at least one element selected from the group consisting of Mn, Co, Fe and Cr
z: a number in the range from 0 to 0.4;
x: a number in the range from 0.1 to 4;
y: a number in the range from x to 2x; and
α: a number which is determined by the valences of the other elements and corresponds to the oxygen deficit.

8. The catalyst as claimed in claim 7, characterized in that the hexaaluminate has a specific surface area of more than 10 m²/g.

9. A catalytic burner, in particular for anode offgas from a fuel cell arrangement, characterized in that the burner comprises the catalyst claimed in claim 7.

10. The catalytic burner as claimed in claim 9, characterized in that the catalyst is applied as a coating to a support.

11. The catalytic burner as claimed in claim 10, characterized in that the support is configured as a monolith.

12. The catalytic burner as claimed in claim 11, characterized in that the monolith has a honeycomb structure.

13. The catalytic burner as claimed in claim 9, characterized in that the catalyst does not comprise any noble metal.

14. A fuel cell arrangement comprising a number of fuel cells which are arranged in a fuel cell stack and further comprising an anode inlet for supplying fuel gas to the anodes of the fuel cells, an anode outlet for discharging the burnt fuel gas from the anodes, a cathode inlet for supplying cathode gas to the cathodes of the fuel cells and a cathode outlet for discharging the spent cathode gas from the cathodes, wherein the catalytic burner as claimed in claim 9 is provided at the anode outlet.

15. The fuel cell arrangement as claimed in claim 14, further comprising a reformer for the steam reforming of hydrocarbons, in particular methane, and a heat exchanger by means of which heat produced in the catalytic burner is conveyed to the reformer.

16. The fuel cell arrangement as claimed in claim 14, characterized in that the fuel cells are configured as MCFCs.

17. The fuel cell arrangement as claimed in claim 14 further comprising a cathode gas conduit by means of which the offgas leaving the catalytic burner is conveyed to the cathode inlet.

18. The fuel cell arrangement as claimed in claim 14 further comprising a protective housing which surrounds the fuel cell stack and the catalytic burner and within which the fuel gas stream circulates.

19. The process as claimed in claim 1, characterized in that the catalyst does not comprise any noble metal.

20. The catalyst as claimed in claim 7, characterized in that the catalyst does not comprise any noble metal.
